(19) United States
(12) Patent Application Publication
(10) Pub. No.: US 2026/0161351 A1
(43) Pub. Date: Jun. 11, 2026

(54) RECOMMENDATION INFORMATION PROCESSING METHOD, APPARATUS, ELECTRONIC DEVICE, STORAGE MEDIUM AND PRODUCT

(71) Applicants: Beijing Zitiao Network Technology Co., Ltd., Beijing (CN); Lemon Inc., Grand Cayman (KY)

(72) Inventors: Minwei GU, Beijing (CN); Xiaochan WANG, Beijing (CN); Zhuochen GE, Beijing (CN); Zhenliang LI, Beijing (CN); Mengjun ZHANG, Beijing (CN); Dongpo LI, Beijing (CN); Qingjian JIAO, Beijing (CN); Ximou CHENG, Beijing (CN); Yulong ZHANG, Beijing (CN); Yang YANG, Beijing (CN); Xiaoguo FENG, Beijing (CN); Jianguo HUO, Beijing (CN); Xiangning ZHU, Beijing (CN); Yuyi HE, Beijing (CN); Han WANG, Beijing (CN); Xiaoyu KANG, Beijing (CN); Da CHENG, Beijing (CN); Jiqin WANG, Beijing (CN)

(21) Appl. No.: 19/410,981

(22) Filed: Dec. 5, 2025

(30) Foreign Application Priority Data
Dec. 9, 2024 (CN) 202411803716.5

(51) Int. Cl. G06F 3/16; G06F 16/334; G06F 16/34; G06F 40/205; G06F 40/30

(52) U.S. Cl. CPC G06F 3/167; G06F 16/3344; G06F 16/345; G06F 40/205; G06F 40/30

(57) ABSTRACT

The present disclosure relates to a recommendation information processing method and apparatus, an electronic device, a storage medium and a product, and relates to the field of artificial intelligence and computer technologies. The recommendation information processing method of the present disclosure includes: acquiring recommendation information; generating colloquial summary information according to the recommendation information; and generating audio corresponding to the summary information and playing the audio through an audio playback device.

### CROSS-REFERENCE TO RELATED APPLICATION

This application claims the benefit under 35 USC 119(a) of Chinese Patent Application No. 202411803716.5, filed on Dec. 9, 2024. The entire disclosure of the prior application is hereby incorporated by reference in its entirety.

### TECHNICAL FIELD

The present disclosure relates to the field of artificial intelligence and computer technologies, and in particular, to a recommendation information processing method and apparatus, an electronic device, a storage medium and a product.

### BACKGROUND

Various applications (Application, APP) may be installed in Users'terminal devices, and these applications may push some recommendation messages (which may also be notification messages) to users to remind them of the latest developments related to the applications when the applications are not open. For example, some applications may push some notification messages to users in the form of a notification bar when the terminal device is in a lock screen state, in a state of displaying a home screen, or in a state of displaying an interface of other applications.

### SUMMARY

According to some embodiments of the present disclosure, a recommendation information processing method is provided, including: acquiring recommendation information; generating colloquial summary information according to the recommendation information; and generating audio corresponding to the summary information and playing the audio through an audio playback device.

According to some other embodiments of the present disclosure, a recommendation information processing method is provided, including: acquiring, by a client, recommendation information in a terminal and sending the recommendation information to a server; generating, by the server, colloquial summary information according to the recommendation information; sending, by the server, a summary complete event to the client; determining, by the client, whether there is a conversation link corresponding to an audio device in response to receiving the summary complete event; establishing, by the client, a conversation link with an audio playback device in response to there being no conversation link corresponding to the audio device; sending, by the client, a trigger message to the server in response to the conversation link being successfully established; generating, by the server, audio corresponding to the summary information according to the summary information in response to receiving the trigger message; sending, by the server, the audio corresponding to the summary information to the client; and sending, by the client, the audio corresponding to the summary information to the audio playback device through the conversation link to play the audio.

According to some yet other embodiments of the present disclosure, an electronic system is provided, including: one or more processors; and one or more memories coupled to the one or more processors and configured to store instructions, wherein the instructions, when executed by the one or more processors, cause the one or more processors to perform the recommendation information processing method according to any one of the embodiments of the present disclosure.

According to some still other embodiments of the present disclosure, a non-transitory computer-readable storage medium is provided, where a computer program is stored on the computer-readable storage medium, and the computer program, when executed by a processor, causes the processor to implement the recommendation information processing method according to any one of the embodiments of the present disclosure.

Other features, aspects and advantages of the present disclosure will become apparent through the following detailed description of exemplary embodiments of the present disclosure with reference to the drawings.

### BRIEF DESCRIPTION OF THE DRAWINGS

Embodiments of the present disclosure are explained hereunder with reference to the drawings. It is to be understood that the drawings in the following description relate only to some embodiments of the present disclosure and are not limiting of the present disclosure. In the drawings:

FIG. 1 is a schematic flowchart of a recommendation information processing method according to some embodiments of the present disclosure;

FIGS. 2 to 6 are schematic diagrams of display interfaces according to some embodiments of the present disclosure;

FIG. 7 is a schematic flowchart of a recommendation information processing method according to some other embodiments of the present disclosure;

FIG. 8 is a schematic diagram illustrating the structure of a recommendation information processing apparatus according to some embodiments of the present disclosure;

FIG. 9 is a schematic diagram illustrating the structure of a recommendation information processing apparatus according to some other embodiments of the present disclosure;

FIG. 10 is a schematic diagram illustrating the structure of an electronic device according to some embodiments of the present disclosure;

FIG. 11 is a schematic diagram illustrating the structure of an electronic device according to some other embodiments of the present disclosure.

### DETAILED DESCRIPTION

The technical solutions in the embodiments of the present disclosure will be described clearly and completely with reference to the drawings in the embodiments of the present disclosure. It is to be understood that the present disclosure may be implemented in various forms and should not be construed as limited to the embodiments set forth herein.

It is to be understood that the various steps recited in the method implementations of the present disclosure may be executed in a different order, and/or executed in parallel. In addition, the method implementations may include additional steps and/or omit to perform illustrated steps. The scope of the present disclosure is not limited in this respect. Unless otherwise specifically stated, the relative arrangement of the components and steps set forth in these embodiments should be construed as merely exemplary and does not limit the scope of the present disclosure.

The term “include/comprise” and variations thereof used in the present disclosure are open-ended terms that mean “include/comprise at least” but do not exclude other elements/features, that is, “include/comprise but not limited to”. The term “based on” means “based at least in part on”.

It is to be noted that concepts such as “first” and “second” mentioned in the present disclosure are only used to distinguish different apparatuses, modules or units, and are not used to limit the order of functions performed by these apparatuses, modules or units or their interdependence. Unless otherwise specified, concepts such as “first” and “second” are not intended to imply that the objects so described must be in a given order in terms of time, space, ranking, or any other order.

It is to be noted that the modifiers of “one” and “multiple” mentioned in the present disclosure are illustrative and not restrictive, and those skilled in the art should understand that they should be understood as “one or more” unless clearly indicated in the context otherwise.

The names of messages or information exchanged between multiple apparatuses in the implementations of the present disclosure are only used for illustrative purposes, and are not used to limit the scope of these messages or information.

The user information (including but not limited to user device information, user personal information, etc.) and data (including but not limited to data for analysis, stored data, displayed data, etc.) involved in the present disclosure are all information and data authorized by users or fully authorized by all parties, and the collection, use and processing of the relevant data need to comply with relevant laws, regulations and standards of relevant countries and regions, and corresponding operation entrance is provided for users to choose to authorize or reject.

Embodiments of the present disclosure are described in detail hereunder with reference to the drawings, but the present disclosure is not limited to these specific embodiments. The following specific embodiments may be combined with each other, and the same or similar concepts or processes may not be repeated in some embodiments. In addition, in one or more embodiments, a particular feature, structure, or characteristic may be combined in any suitable manner that will be clear to those of ordinary skill in the art from this disclosure.

The terminal device may also be referred to as a terminal, a user equipment, etc., and may be a terminal in various forms such as a mobile phone, a tablet computer, a virtual reality (Virtual Reality, VR) terminal device, an augmented reality (Augmented Reality, AR) terminal device, etc., which is not limited in the present disclosure.

Applications in users'terminal devices may send some recommendation information (or notification messages) when the applications are not open. The recommendation information is usually displayed on the terminal devices in the form of text, and users may miss the recommendation information if they have difficulty reading. Some terminal device systems are configured with audio processing applications, and users may configure an audio processing application to broadcast the recommendation information. When users have difficulty reading the recommendation information, they need to wake up the audio processing application to broadcast the recommendation information. However, the audio processing application may only read every word in the recommendation information verbatim, and when there are a relatively large quantity of recommendation information, broadcasting the recommendation information item by item and word by word may lead to a long broadcast time but a low information density, which makes it impossible for users to quickly and accurately understand the content of the recommendation information. Moreover, because such a broadcast mode sounds relatively rigid, it is difficult for users to understand and grasp the key information therein, rendering a poor broadcast effect.

Based on the above problems, the present disclosure provides a recommendation information processing method. After recommendation information are acquired, the recommendation information may be summarized to generate colloquial summary information, and then audio corresponding to the summary information is generated and played through an audio playback device. Through the recommendation information processing method, the recommendation information may be summarized into summary information with a higher information density, and the colloquial expression is used, so that users may understand the content of the recommendation information more quickly and accurately, and the effect of broadcasting the recommendation information is improved.

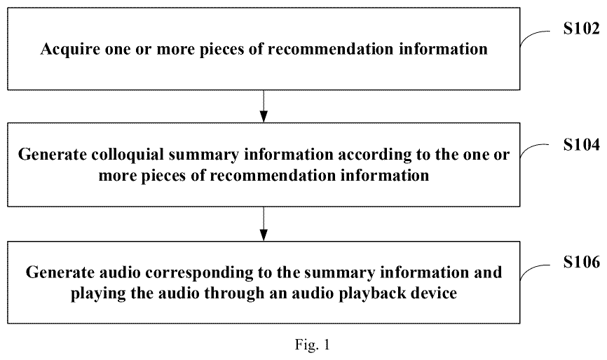

Some embodiments of the recommendation information processing method of the present disclosure are described hereunder with reference to FIGS. 1 to 7.

FIG. 1 is a flowchart of some embodiments of a recommendation information processing method of the present disclosure. As shown in FIG. 1, the method in these embodiments includes steps S102 to S106.

In step S102, recommendation information are acquired.

One or more pieces of recommendation information may be sent by one or more applications. The one or more pieces of recommendation information may be sent and displayed in the form of system notification messages or in other forms. In a case where the one or more pieces of recommendation information are sent in the form of system notification messages, the one or more pieces of recommendation information may be acquired through a system notification message acquisition protocol or permission. For example, notification messages in a system notification bar are acquired through the Apple ancs protocol or Android application access notification permission.

In step S104, colloquial summary information is generated according to the recommendation information.

The one or more pieces of recommendation information may involve different contents and different forms, and may be expressed in written language usually. If the text of the one or more pieces of recommendation information is simply converted into audio for broadcasting, the information density is low, the language expression is rigid, and it is difficult for users to understand key information. Semantic understanding may be performed on the one or more pieces of recommendation information, and the one or more pieces of recommendation information may be summarized to generate colloquial summary information. The summary information contains the key information of the one or more pieces of recommendation information, and the colloquial expression is used, so that users may understand the recommendation information quickly and accurately. Even one piece of recommendation information may be converted into colloquial summary information so that users may understand the content thereof more quickly and accurately. For example, the summary information may be expressed from a perspective or in a tone of an assistant, so that users may experience as if a real human assistant has summarized the acquired one or more pieces of recommendation information and informed the users.

In step S106, audio corresponding to the summary information is generated and played through an audio playback device.

The summary information may be in a form of text, and the text of the summary information is converted into audio and played through the audio playback device. The audio playback device may be an audio playback device such as a headphone or a speaker that may be connected to a terminal device, or may be an audio playback device built in the terminal device.

In the method in the above embodiments, after recommendation information are acquired, the recommendation information are summarized to generate colloquial summary information, and then audio corresponding to the summary information is generated and played through the audio playback device. In a case where users have difficulty reading or do not want to read the recommendation information, the recommendation information may be summarized by the method in the above embodiments, the key information therein may be extracted to form summary information with a higher information density and a more natural expression, and the content of the recommendation information may be quickly and accurately understood by users through voice broadcast, which is convenient for users and improves the user experience. In addition, compared with the mode of directly converting recommendation information into audio for broadcasting, the method in the above embodiments improves the efficiency and accuracy of users'understanding of the recommendation information, and improves the user experience.

The recommendation information processing method of the present disclosure may be performed by the recommendation information processing apparatus, and the recommendation information processing apparatus may be a client, a server, or an apparatus including the client and the server, which is not limited here. In some embodiments, the client acquires the recommendation information; the client generates the colloquial summary information according to the recommendation information; and the client generates the audio corresponding to the summary information and plays the audio through the audio playback device. Alternatively, in some embodiments, the server acquires the recommendation information; the server generates the colloquial summary information according to the recommendation information; and the server generates the audio corresponding to the summary information and plays the audio through the audio playback device. Alternatively, in some embodiments, the client acquires the recommendation information and sends the recommendation information to the server; the server generates the colloquial summary information according to the recommendation information, generates the audio corresponding to the summary information, and sends the audio corresponding to the summary information to the client; and the client plays the audio corresponding to the summary information through the audio playback device. Steps performed by the client and the server may be determined according to actual capabilities and actual requirements of the client and the server, which is not limited to the above examples.

The client may be an agent application, and the server may also be an agent server, that is, the recommendation information processing method of the present disclosure may be performed by an agent, and the agent may include at least one of the client or the server.

The one or more pieces of recommendation information in a user's terminal device may be acquired according to the user's configuration, which is described hereunder with reference to some embodiments.

In some embodiments, the recommendation information corresponding to one or more applications are acquired in response to a user enabling a broadcast function of recommendation information and configuring the one or more applications corresponding to the recommendation information to be broadcast.

The user may configure to enable the broadcast function of recommendation information, configure one or more applications of the recommendation information to be broadcast, and may also configure message types of the recommendation information to be broadcast in the one or more applications. A management interface of the audio playback device may be displayed, and the management interface includes a control corresponding to the broadcast function. In response to the user triggering the control, a first configuration interface is displayed. The first configuration interface includes a broadcast function enabling control. In response to the user triggering the enabling control, a second configuration interface is displayed. The second configuration interface includes one or more configuration controls of one or more applications. In response to the user triggering a configuration control of any of the one or more applications, a configuration interface of the application is displayed, and in response to the user selecting a message type in the configuration interface, a correspondence between the message type and the application is stored.

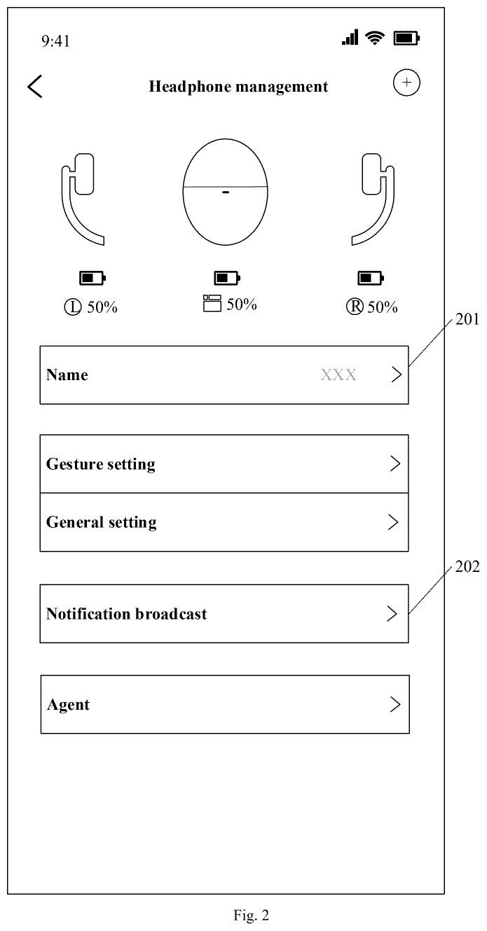

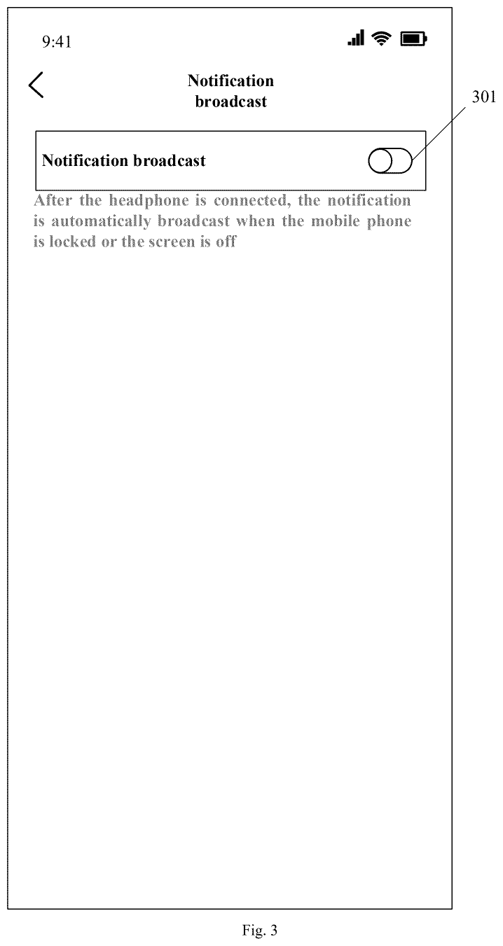

As shown in FIG. 2, taking the audio playback device as a headphone for an example, a headphone management interface may be displayed. In the headphone management interface, a headphone name management control 201 and a control 202 corresponding to the broadcast function may be displayed. The name management control 201 may be used to modify a name of the headphone, etc. The headphone management interface may also include a gesture setting control for configuring gestures for turning on, pausing, etc. of the headphone. A general setting control may configure a volume, connection mode, etc. of the headphone, which is not limited to the example shown. In response to the user triggering the control 202 corresponding to the broadcast function, a first configuration interface shown in FIG. 3 may be displayed.

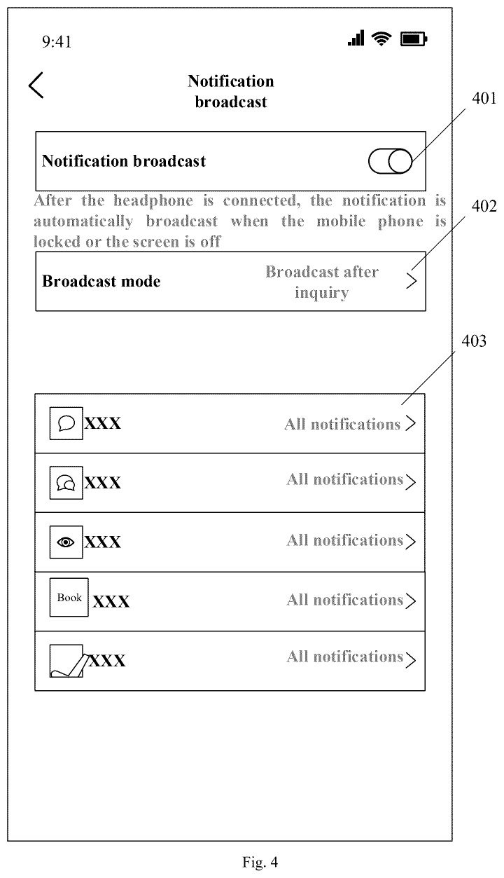

As shown in FIG. 3, a broadcast function enabling control 301 may be displayed in the first configuration interface, and the user may enable or disable the broadcast function by triggering the enabling control 301. In response to the user triggering the enabling control 301, a second configuration interface shown in FIG. 4 may be displayed.

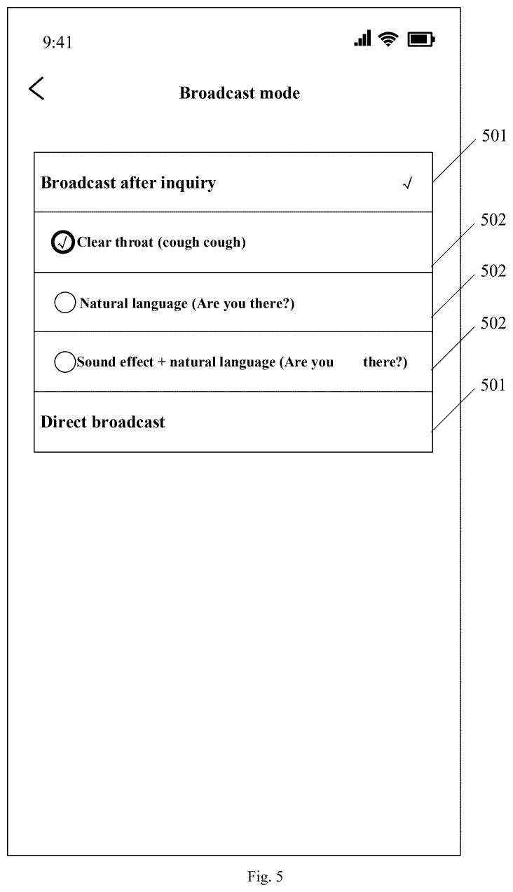

As shown in FIG. 4, the broadcast function enabling control 401 may be displayed in the second configuration interface, and the user may enable or disable the broadcast function by triggering the enabling control 401. As shown in FIG. 4, a broadcast mode configuration control 402 may also be displayed in the second configuration interface, and in response to the user triggering the broadcast mode configuration control 402, a third configuration interface shown in FIG. 5 is displayed.

As shown in FIG. 5, a selection area 501 corresponding to a plurality of broadcast modes may be displayed in the third configuration interface, and a selection area 502 of a plurality of prompt tones may also be displayed in the third configuration interface. In response to the user selecting a broadcast mode and a prompt tone, the broadcast mode and the prompt tone selected by the user are stored. For example, the broadcast modes include broadcast after inquiry and direct broadcast. In response to the user selecting broadcast after inquiry, inquiry information is sent to the user after the recommendation information is acquired, for example, “Recommendation information is received. Do you want to broadcast?” In response to the user confirming to broadcast, the subsequent process of generating the summary information and broadcasting the summary information is performed. In response to the user selecting direct broadcast, the subsequent process of generating the summary information and broadcasting the summary information may be performed after the recommendation information is acquired.

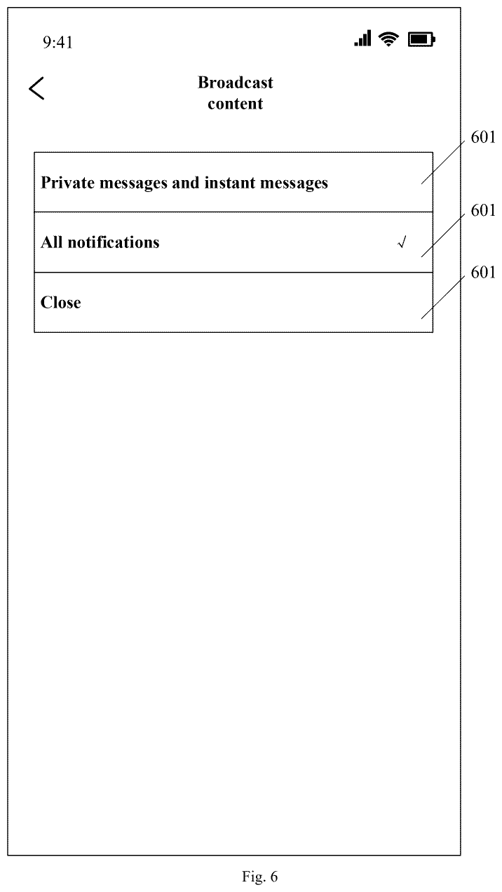

As shown in FIG. 4, the configuration controls 403 of one or more applications may also be displayed in the second configuration interface, and in response to the user triggering any configuration control 403 of the one or more applications, an application configuration interface shown in FIG. 6 is displayed. The application configuration interface includes a selection area 601 of a plurality of message types. The user may configure which message types of recommendation information in the application may be broadcast, for example, configure all recommendation information to be broadcast or configure a certain message type or a plurality of message types (private messages and instant messages) of recommendation information to be broadcast.

In the method in the above embodiments, users may be provided with more flexible and diverse configuration modes, so that users may configure whether to enable the broadcast function and which applications'recommendation information to broadcast according to their own needs, making the broadcast of recommendation information more accurate and in line with the users' needs.

In some embodiments, audio of a prompt tone configured by a user and the audio corresponding to the summary information are played through the audio playback device, where the prompt tone is configured to prompt the user that broadcast is about to start.

Through the configuration of the prompt tone, the user may be reminded before broadcast, so that the user may pay attention to the broadcast information thereafter, improving the user experience.

How to generate the summary information according to the recommendation information is described hereunder with reference to some embodiments.

In some embodiments, key information in the recommendation information is determined according to semantic information of the recommendation information; auxiliary information associated with the key information is determined according to the key information; and the colloquial summary information is generated according to the key information and the auxiliary information.

The machine learning model may be used to perform semantic understanding on the one or more pieces of recommendation information to determine the semantic information, thereby identifying the key information and the auxiliary information in the one or more pieces of recommendation information. For example, the machine learning model is an LLM (Large Language Model, large language model), etc., which is not limited to the example shown. For example, the key information is event information in the one or more pieces of recommendation information, and the auxiliary information is information on relevant conditions (time, place, etc.) for the occurrence of the event, which is not limited to the example shown.

In some embodiments, the colloquial summary information is generated via the machine learning model according to the key information, the auxiliary information, and prompt, where the prompt includes task description information for instructing to use a colloquial expression and one or more examples of using the colloquial expression.

The one or more pieces of recommendation information and the prompt may be input into the machine learning model, and the prompt includes the task description information for instructing to use the colloquial expression and the one or more examples of using the colloquial expression. The prompt may also include at least one of input description information or output description information, and the task description information may also instruct the machine learning model to extract indication information of the key information and the auxiliary information from the input information. The machine learning model may determine the key information and the auxiliary information from the input one or more pieces of recommendation information based on the prompt, and generate the colloquial summary information.

In the method in the above embodiments, the semantic information of the one or more pieces of recommendation information is understood, the key information and the auxiliary information are determined, and the colloquial summary information is generated, so that the key information of the recommendation information may be retained, and the semantics may be made more complete and accurate with the assistance of the auxiliary information, thereby improving the accuracy of generating the summary information. In addition, the prompt is used to guide the machine learning model to generate the colloquial summary information, so that the generated summary information is easier to understand and higher in accuracy.

In a case where there are a plurality of pieces of recommendation information, the plurality of pieces of recommendation information may be from different sources and have different contents. How to summarize the plurality of pieces of recommendation information is described hereunder with reference to some embodiments.

In some embodiments, in response to acquiring each piece of the recommendation information, a group corresponding to each piece of the recommendation information is determined according to at least one of content or a source corresponding to each piece of the recommendation information, where different types of groups correspond to different trigger conditions, and the trigger conditions include at least one of a trigger time or a quantity threshold of recommendation information in a group; and in response to a trigger condition of a certain group being satisfied, summary information of the group is generated according to recommendation information in the group.

Different types of groups may be set, and different types of groups correspond to different trigger conditions. For example, a trigger time corresponding to a group of type A is 30 seconds, a quantity threshold of recommendation information is 10, a trigger time corresponding to a group of type B is 1 minute, and a quantity threshold of recommendation information is 20. The trigger time may be a trigger time interval, that is, summary information is generated and broadcast once every trigger time interval.

Each time one piece of recommendation information is received, it may be divided into a group, and a type of the group and a trigger condition of the group are determined. When the trigger condition of a certain group is satisfied, for example, the trigger time is reached and/or the quantity of recommendation information in the group reaches the quantity threshold, the recommendation information in the group is summarized to generate colloquial summary information, and the colloquial summary information is broadcast.

In the method in the above embodiments, the group of each of the one or more pieces of recommendation information is determined according to at least one of the content or the source of each of the one or more pieces of recommendation information. Different groups and different group types are distinguished, and different trigger conditions are used to trigger the generation of the summary information. In this way, in a case where there is a large amount of recommendation information, recommendation messages with different contents and from different sources may be summarized and broadcast in batches and in sequence, thereby improving the efficiency of summarization and broadcast, and adapting to different requirements of different recommendation information for real-time performance of broadcast.

How to determine the group of each piece of recommendation information is described hereunder with reference to some embodiments.

In some embodiments, an urgency degree corresponding to each piece of the recommendation information is determined via semantic understanding on content of each piece of recommendation information to; and the group corresponding to each piece of the recommendation information is determined according to the urgency degree corresponding to each piece of the recommendation information, where a group with a higher urgency degree corresponds to an earlier trigger time and a lower quantity threshold.

Each time one piece of recommendation information is acquired, semantic understanding may be performed on the one piece of recommendation information to determine the urgency degree of the one piece of recommendation information. For example, the machine learning model may be used to determine the urgency degree of each of the one or more pieces of recommendation information. Recommendation information with different urgency degrees may be divided into different groups, and a group with a higher urgency degree corresponds to an earlier trigger time and a lower quantity threshold. For example, if a certain piece of recommendation information is a message notifying the user to get to a certain place as soon as possible, it may be determined that the recommendation information belongs to recommendation information with a high urgency degree, and is divided into a group of a type with a short corresponding trigger time or a low quantity threshold, then the recommendation information will be summarized and broadcast as soon as possible. For recommendation information with the highest urgency degree, the recommendation information may be acquired and summarized and broadcast immediately. A correspondence between different urgency degrees and different group types and different trigger conditions may be pre-configured.

In the method in the above embodiments, the urgency degree of each of the one or more pieces of recommendation information is determined according to the semantic information of each of the one or more pieces of recommendation information, and then each of the one or more pieces of recommendation information is allocated to a group with a different trigger condition, so that recommendation information with a higher requirement for real-time performance is summarized and broadcast as soon as possible, and recommendation information with a lower requirement for real-time performance is summarized and broadcast subsequently, thereby improving the effect of summarization and broadcast, and making it more in line with the users'needs.

In some embodiments, each piece of the recommendation information is parsed to identify a source corresponding to each piece of the recommendation information, where the source includes at least one of an application or a sending user; and the group corresponding to each piece of the recommendation information is determined according to at least one of the application or the sending user corresponding to each piece of the recommendation information, where different applications correspond to different groups, and sending users with different priorities correspond to different groups.

The user may configure priorities of one or more sending users. For example, in response to the user triggering an operation of a priority configuration function, a plurality of users having a preset relationship with the user are displayed, for example, the preset relationship is a friend relationship, or the plurality of users having the preset relationship with the user are users in the user's address book. In response to the user configuring priorities of one or more users, the priorities of the one or more users are stored. In a case where the recommendation information is sent by the one or more users, the one or more users may be used as one or more sending users, and one or more priorities of the one or more sending user are determined. A sending user may be a single user or a group.

For example, recommendation information pushed by different applications may be divided into different groups. In a case where a plurality of pieces of recommendation information belong to the same application but different sending users with different priorities, the plurality of pieces of recommendation information may be divided into different groups according to the priorities of the sending users. For an application with a higher requirement for timeliness, a group in which the application is located corresponds to an earlier trigger time and a lower quantity threshold. A group in which a sending user with a higher priority is located corresponds to an earlier trigger time and a lower quantity threshold.

In the method in the above embodiments, the group of each of the one or more pieces of recommendation information is determined according to at least one of the application or the sending user corresponding to each of the one or more pieces of recommendation information, so that recommendation information of different applications and different sending users may be better summarized separately, instead of mixing all recommendation information together for summarization, thereby improving the accuracy of summarization, and enabling the user to understand the summary information more quickly and accurately.

In some embodiments, each piece of the recommendation information is parsed to identify a source corresponding to each piece of the recommendation information, where the source includes at least one of an application or a sending user; a message type and an urgency degree corresponding to each piece of the recommendation information are determined via semantic understanding on each piece of the recommendation information; and the group corresponding to each piece of the recommendation information is determined according to at least one of the application or the sending user corresponding to each piece of the recommendation information, the message type, and the urgency degree.

For example, the message type includes an instant messaging message, a status update message, an advertisement message, etc., and the division of the message type is determined according to specific configuration of the application. The same application may send recommendation information of different message types, which is not limited to the example shown. A reference is made to the source, the message type and the urgency degree of each of the one or more pieces of recommendation information to determine the group of each of the one or more pieces of recommendation information, so that the recommendation information may be more accurately grouped, and groups are summarized separately, thereby improving the accuracy of summarization. In addition, different groups may correspond to different trigger conditions, so as to adapt to different requirements of different recommendation information for real-time performance.

In some embodiments, key information in the recommendation information in the group is determined according to semantic information of the recommendation information in the group in an order of sending time of the recommendation information in the group; auxiliary information associated with the key information is determined according to the key information; and the summary information of the group is generated using a colloquial expression according to the key information, the auxiliary information, and the sending user, where a plurality of pieces of recommendation information continuously sent by one sending user in one event are summarized together.

The machine learning model may be used to summarize the recommendation information in each group to generate the summary information of each group. When summarizing a plurality of pieces of recommendation information in a group, semantic understanding and summarization need to be performed in the order of the sending time of the recommendation information from early to late, and a plurality of pieces of recommendation information continuously sent by the same sending user for the same event may be summarized together. The summary information includes the key information and the auxiliary information, and may also include information of the sending user and information of the application. For example, the recommendation information is a plurality of messages from an application A: [12:00:00] Xiaomei: Do you want to go out and play today? [12: 00:30] Xiaomei: It's not hot in the evening. [12: 01:55] Xiaomei: How about going for a walk in the park? The generated summary information is that Xiaomei is asking you on A if you want to go for a walk in the park tonight?

In the method in the above embodiments, more accurate summary information may be generated for each group, so that the user may understand the content of the recommendation information more quickly and accurately.

For example, after the summary information is generated, TTS (Text-to-Speech) technology may be used to generate the audio corresponding to the summary information, which is not limited to the example shown.

The audio corresponding to the summary information may be sent to the audio playback device through a conversation link between the audio playback devices for broadcast. In some embodiments, whether there is a conversation link corresponding to the audio playback device is determined; in response to there being a conversation link corresponding to the audio playback device, the audio corresponding to the summary information is sent to the audio playback device through the conversation link to play the audio; and in response to there being no conversation link corresponding to the audio playback device, a conversation link with the audio playback device is established, and the audio corresponding to the summary information is sent to the audio playback device through the conversation link to play the audio.

The conversation link may be a conversation link between the client and the audio playback device. In a connection state of the audio playback device and the terminal device, a conversation link is not necessarily established between the audio playback device and the terminal device. Some audio playback devices need to be woken up by the user to establish a conversation link with a corresponding client for playing and a subsequent conversation. For example, the user wakes up the audio playback device by voice-inputting the name of the audio playback device. However, in the method in the above embodiments, whether there is a conversation link corresponding to the audio playback device is automatically determined, and in the absence of the conversation link, the conversation link with the audio playback device is automatically established, thereby implementing active broadcast of the audio corresponding to the summary information, and improving the user experience.

While broadcasting the summary information, the summary information may also be displayed. For example, the summary information may be displayed in the form of recommendation information, but the recommendation information is no longer summarized and broadcast. For example, in response to the user enabling the client or the application, the summary information is displayed in the interactive interface, which is not limited to the example shown.

It is mentioned in the above embodiments that the recommendation information processing method of the present disclosure may be performed by a client or a server, or may also be performed by the client and the server together. A solution performed by the client and the server together is described hereunder with reference to some embodiments.

In some embodiments, the client sends the one or more pieces of recommendation information to the server; the server generates the summary information according to the one or more pieces of recommendation information; and the server sends the summary complete event to the client.

In some embodiments, the client determines whether there is a conversation link corresponding to an audio playback device in response to receiving the summary complete event; and the client establishes a conversation link with the audio playback device in response to there being no conversation link corresponding to the audio device.

In some embodiments, in response to the conversation link being successfully established, the client sends a trigger message to the server; the server generates the audio corresponding to the summary information according to the summary information; the server sends the audio corresponding to the summary information to the client; and the client sends the audio corresponding to the summary information to the audio playback device through the conversation link to play the audio.

In some embodiments, the client acquires the recommendation information in the terminal and sends the recommendation information to the server; the server generates the colloquial summary information according to the recommendation information; the server sends the summary complete event to the client; the client determines whether there is a conversation link corresponding to an audio playback device in response to receiving the summary complete event; the client establishes a conversation link with the audio playback device in response to there being no conversation link corresponding to the audio device; the client sends the trigger message to the server in response to the conversation link being successfully established; the server generates the audio corresponding to the summary information according to the summary information in response to receiving the trigger message; the server sends the audio corresponding to the summary information to the client; and the client sends the audio corresponding to the summary information to the audio playback device through the conversation link to play the audio.

In the method in the above embodiments, a solution of interaction between the client and the server is provided, to implement a solution of automatically summarizing and automatically broadcasting the recommendation information, thereby improving the effect of automatic broadcast, and improving the user experience.

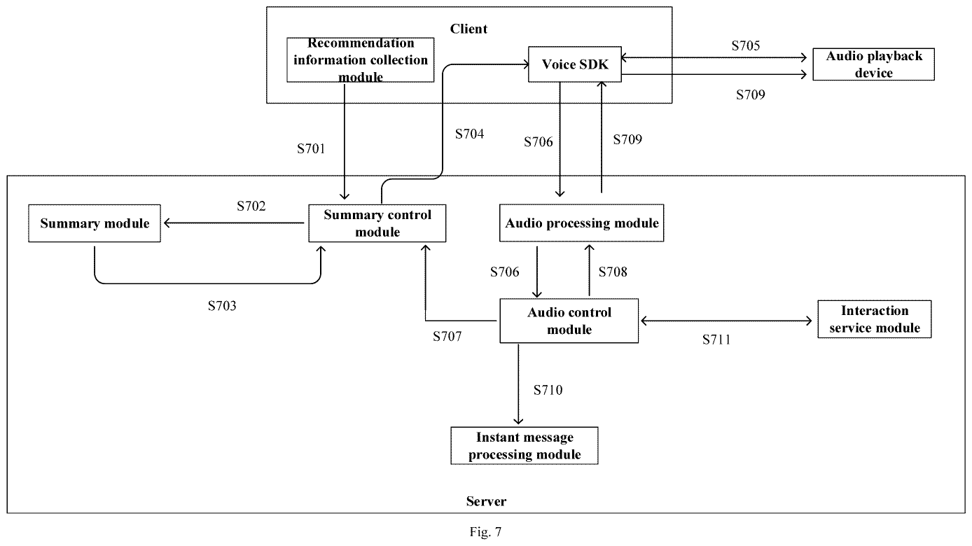

FIG. 7 is a flowchart of some other embodiments of a recommendation information processing method of the present disclosure. As shown in FIG. 7, the method in these embodiments includes steps S701 to S711. As shown in FIG. 7, the client includes a recommendation information collection module and a voice SDK (Software Development Kit). The server includes a summary control module, a summary module, an audio control module, an audio processing module, an interaction service module and an instant message processing module.

In step S701, the recommendation information collection module acquires one or more pieces of recommendation information and sends the one or more pieces of recommendation information to the summary control module.

In step S702, the summary control module sends the one or more pieces of recommendation information to the summary module.

In step S703, the summary module generates colloquial summary information according to the one or more pieces of recommendation information, and sends the summary information to the summary control module.

In step S704, the summary control module sends a summary complete event to the voice SDK.

In step S705, the voice SDK establishes a conversation link with the audio playback device.

In step S706, the voice SDK sends a trigger message to the audio control module through the audio processing module.

In step S707, the audio control module acquires the summary information from the summary control module.

In step S708, the audio control module sends the summary information to the audio processing module.

In step S709, the audio processing module generates the audio corresponding to the summary information, and sends the audio to the audio playback device through the voice SDK to play the audio.

The audio processing module may send a prompt tone to the audio playback device through the voice SDK to play the prompt tone first, and then send the audio corresponding to the summary information to the audio playback device through the voice SDK to broadcast the audio.

In step S710, the audio control module sends the summary information to the instant message processing module.

The instant message processing module may perform processing related to displaying the summary information on a screen.

In step S711, the audio control module interacts with the interaction service module to process interaction information of the user.

The user may ask questions, etc. according to the broadcast summary information, and therefore, the subsequent recommendation information processing apparatus may further interact with the user.

A method for how the recommendation information processing apparatus interacts with the user is described hereunder with reference to some embodiments.

In some embodiments, in response to receiving input information from a user, whether the input information is relevant to the recommendation information is determined via semantic understanding on the input information; in response to the input information being relevant to the recommendation information, colloquial first reply information is generated according to the input information and the recommendation information; and audio corresponding to the first reply information is generated and played through the audio playback device.

If the user's input information is received during the broadcast of the summary information, the broadcast may be stopped. The input information may be in the form of voice or text. It may be determined whether the input information is relevant to the one or more pieces of recommendation information based on the semantic understanding of the input information. If the input information is not relevant to the one or more pieces of recommendation information, the first reply information and the audio corresponding to the first reply information may be generated directly according to the input information, and the audio corresponding to the first reply information is played through the audio playback device. In a case where the user inputs text through the interactive interface, it is also possible to only display the first reply information, not generate the audio corresponding to the first reply information, and not broadcast.

If the input information is relevant to the one or more pieces of recommendation information, the first reply information is generated according to the input information and the one or more pieces of recommendation information. For example, the recommendation information is to recommend a new article of a blogger subscribed by the user, and the user may ask a question about the new article, and then the first reply information is generated according to the user's question and relevant content of the new article. Information about an object corresponding to the one or more pieces of recommendation information may be further acquired according to the one or more pieces of recommendation information, and the first reply information is generated according to the input information and the information about the object.

In the method in the above embodiments, it is convenient for the user to learn about the information related to the recommendation information, and by determining whether the user's input information is relevant to the recommendation information and generating the first reply information according to the recommendation information and the input information, the accuracy of the generated first reply information is improved.

In some embodiments, second reply information associated with the first reply information is generated according to the input information and the recommendation information, where the second reply information includes at least one of search content or generative content associated with the first reply information; and the second reply information is displayed.

The content of reply may be further expanded for the user's input information, so as to provide the user with richer and more diverse reply content, thereby improving the user experience. If the second reply information is suitable for broadcast, audio of the second reply information may also be generated and broadcast through the audio playback device. If the second reply information is not suitable for broadcast, such as a link, a picture, etc., the second reply information may be displayed when the user opens the application or the client. A guiding voice may also be played to guide the user to view the displayed second reply information.

In some embodiments, semantic information is determined according to the input information, and a manner of generating the second reply information is determined, where the manner includes at least one of a search manner or a generative manner; in response to the manner including the search manner, content for replying to the input information is searched for according to the semantic information of the input information and the recommendation information to obtain the search content as the second reply information; in response to the manner including the generative manner, content for replying to the input information is generated according to the semantic information of the input information and the recommendation information to obtain the generative content as the second reply information; and in response to the manner including the search manner and the generative manner, content for replying to the input information is searched for according to the semantic information of the input information and the recommendation information to obtain the search content, the generative content is obtained by summarizing the search content, and the search content and the generative content are combined to obtain the second reply information.

A search engine may be used to acquire the search content, and a generative model may be used to obtain the generative content. It may be determined which manner is suitable for generating the second reply information according to the user's input information. For example, in response to the user's input information including indication information indicating the manner of generating the second reply information, the second reply information is determined according to the indication information. For example, the user's input information includes understanding, summarizing, etc. of the information about the object corresponding to the recommendation information, and it may be determined that the manner of generating the second reply information is the generative manner.

In response to the user's input information being relevant to a preset field, and the preset field being suitable for generating the second reply information in a manner of combining the search manner and the generative manner, content for replying to the input information is searched for according to the semantic information of the input information and the one or more pieces of recommendation information to obtain the search content, and the generative content is obtained according to the summary of the search content. For example, the recommendation information is related information of a newly released movie, and the user wants to know some classic movies of the same type, and therefore, relevant videos of some classic movies of the same type may be searched for, and the second reply information may be generated in combination with the content of the relevant videos. It is also possible to search for a plurality of pieces of content for replying to the input information according to the semantic information of the input information and the one or more pieces of recommendation information, and at the same time, generate the content replied by the user, that is, the generative content, according to the semantic information of the input information and the one or more pieces of recommendation information, match the plurality of pieces of content obtained through searching with the generative content, and select one or more pieces of content obtained through searching to be combined with the generative content to obtain the second reply information.

A layout manner of the search content and the generative content may be determined according to the importance of the search content and the generative content, and the search content and the generative content are combined to obtain the second reply information according to the determined layout manner. For example, in a case where the generative content is the main content and the search content is the auxiliary content, the generative content may be highlighted, and vice versa, the search content may be highlighted.

In the method in the above embodiments, how to generate the second reply information is determined based on the semantic understanding of the input information, so that more accurate second reply information may be generated according to the user's intention, thereby improving the user experience.

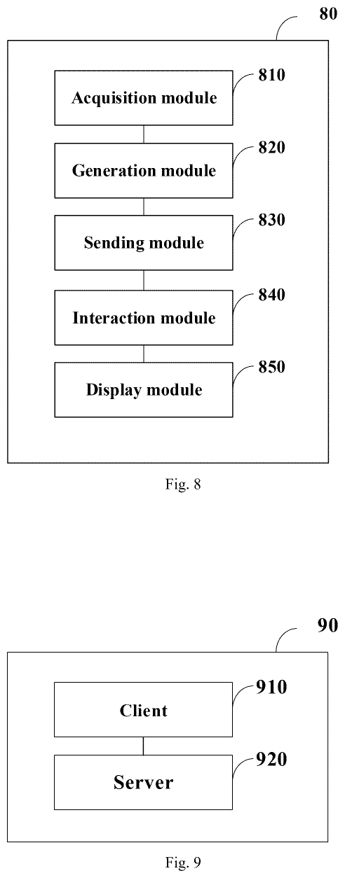

The present disclosure also provides a recommendation information processing apparatus, which is described hereunder with reference to FIG. 8.

FIG. 8 is a structural diagram of some embodiments of a recommendation information processing apparatus of the present disclosure. As shown in FIG. 8, the processing apparatus 80 in these embodiments includes: an acquisition module 810, a generation module 820, and a sending module 830.

The acquisition module 810 is configured to acquire recommendation information in a terminal; the generation module 820 is configured to generate colloquial summary information according to the recommendation information; and the sending module 830 is configured to generate audio corresponding to the summary information and play the audio through an audio playback device.

In some embodiments, the sending module 830 is configured to determine whether there is a conversation link corresponding to the audio playback device; in response to there being a conversation link corresponding to the audio playback device, send the audio corresponding to the summary information to the audio playback device through the conversation link to play the audio; and in response to there being no conversation link corresponding to the audio playback device, establish the conversation link with the audio playback device, and send the audio corresponding to the summary information to the audio playback device through the conversation link to play the audio.

In some embodiments, the generation module 820 is configured to determine key information in the recommendation information according to semantic information of the recommendation information; determine auxiliary information associated with the key information according to the key information; and generate the colloquial summary information according to the key information and the auxiliary information.

In some embodiments, the generation module 820 is configured to generate the colloquial summary information via a machine learning model according to the key information, the auxiliary information, and prompt, where the prompt includes task description information for instructing to use a colloquial expression and one or more examples of using the colloquial expression.

In some embodiments, the processing apparatus 80 further includes an interaction module 840 configured to determine whether the input information is relevant to the recommendation information via semantic understanding on input information in response to receiving the input information from a user; and generate colloquial first reply information according to the input information and the recommendation information in response to the input information being relevant to the recommendation information; and the sending module 830 is further configured to generate audio corresponding to the first reply information and play the audio through the audio playback device.

In some embodiments, the interaction module 840 is further configured to generate second reply information associated with the first reply information according to the input information and the recommendation information, where the second reply information includes at least one of search content or generative content associated with the first reply information; and the processing apparatus 80 further includes a display module 850 configured to display the second reply information.

In some embodiments, the interaction module 840 is configured to determine semantic information according to the input information and determine a manner of generating the second reply information, where the manner includes at least one of a search manner or a generative manner; in response to the manner including the search manner, search for content for replying to the input information according to the semantic information of the input information and the recommendation information to obtain the search content as the second reply information; in response to the manner including the generative manner, generate content for replying to the input information according to the semantic information of the input information and the recommendation information to obtain the generative content as the second reply information; and in response to the manner including the search manner and the generative manner, search for content for replying to the input information according to the semantic information of the input information and the recommendation information to obtain the search content, summarize the search content to obtain the generative content, and combine the search content and the generative content to obtain the second reply information.

In some embodiments, the generation module 820 is configured to in response to acquiring each of the recommendation information, determine a group corresponding to each piece of the recommendation information according to at least one of content or a source corresponding to each piece of the recommendation information, where different types of groups correspond to different trigger conditions, and the trigger conditions include at least one of a trigger time or a quantity threshold of recommendation information in a group; and in response to a trigger condition of a certain group being satisfied, generate summary information of the group according to recommendation information in the group.

In some embodiments, the generation module 820 is configured to determine an urgency degree corresponding to each piece of the recommendation information via semantic understanding on the content of each piece of the recommendation information ; and determine the group corresponding to each piece of the recommendation information according to the urgency degree corresponding to each piece of the recommendation information, where a group with a higher urgency degree corresponds to an earlier trigger time and a lower quantity threshold.

In some embodiments, the generation module 820 is configured to parse each piece of the recommendation information to identify the source corresponding to each piece of the recommendation information, where the source includes at least one of an application or a sending user; and determine the group corresponding to each piece of the recommendation information according to at least one of the application or the sending user corresponding to each piece of the recommendation information, where different applications correspond to different groups, and sending users with different priorities correspond to different groups.

In some embodiments, the generation module 820 is configured to parse each piece of the recommendation information to identify the source corresponding to each piece of the recommendation information, where the source includes at least one of an application or a sending user; determine a message type and an urgency degree via semantic understanding on each piece of the of recommendation information ; and determine the group corresponding to each piece of the recommendation information according to at least one of the application or the sending user corresponding to each piece of the recommendation information, the message type, and the urgency degree.

In some embodiments, the generation module 820 is configured to determine key information in the recommendation information in the group according to semantic information of the recommendation information in the group in an order of sending time of the recommendation information in the group; determine auxiliary information associated with the key information according to the key information; and generate the summary information of the group using a colloquial expression according to the key information, the auxiliary information, and the sending user, where a plurality of pieces of recommendation information continuously sent by one sending user in one event are summarized together.

In some embodiments, the acquisition module 810 is configured to in response to a user turning on a broadcast function of recommendation information and configuring one or more applications corresponding to the recommendation information to be broadcast, acquire the recommendation information corresponding to the one or more applications.

In some embodiments, the sending module 830 is configured to broadcast audio of a prompt tone configured by the user and the audio corresponding to the summary information through the audio playback device, where the prompt tone is configured to prompt the user that the broadcast is about to start.

The recommendation information processing apparatus may execute the recommendation information processing method in any embodiment of the present disclosure to achieve the same effect, which is not repeated here.

The present disclosure also provides a recommendation information processing apparatus, which is described hereunder with reference to FIG. 9.

FIG. 9 is a structural diagram of some embodiments of a recommendation information processing apparatus of the present disclosure. As shown in FIG. 9, the processing apparatus 90 in these embodiments includes: a client 910 and a server 920.

The client 910 is configured to acquire recommendation information in a terminal, send the recommendation information to the server 920, determine whether there is a conversation link corresponding to an audio device in response to receiving a summary complete event sent by the server 920, establish a conversation link with an audio playback device in response to there being no conversation link corresponding to the audio device, send a trigger message to the server 920 in response to the conversation link being successfully established, receive audio corresponding to summary information sent by the server 920, and send the audio corresponding to the summary information to the audio playback device through the conversation link to play the audio;

The server 920 is configured to generate colloquial summary information according to the notification information, send the summary complete event to the client 910, generate audio corresponding to the summary information according to the summary information in response to receiving the trigger message sent by the client 910, and send the audio corresponding to the summary information to the client 910.

The client and the server may respectively execute the methods executed by the client and the server in any embodiment of the present disclosure, which will not be repeated here, and the same effects may be achieved, which will not be repeated here.

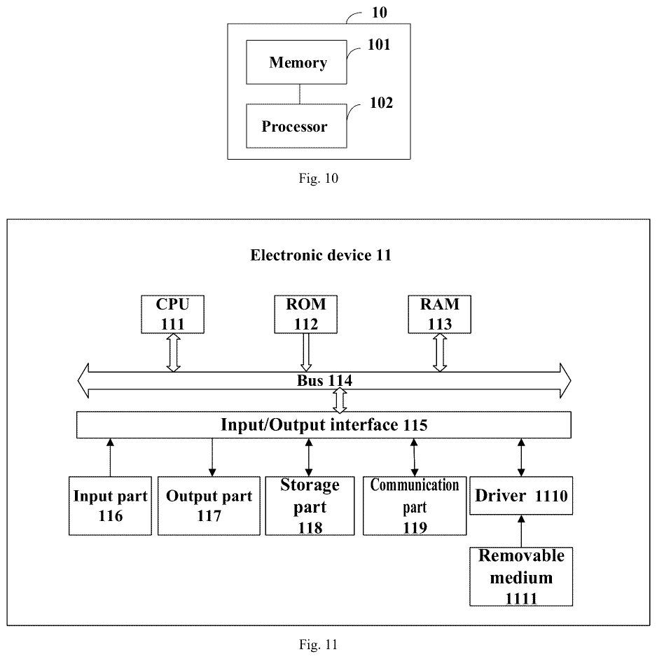

FIG. 10 shows a block diagram of an electronic device according to some embodiments of the present disclosure.

A memory 101 is used to store one or more computer-readable instructions. The memory 101 may include any combination of various forms of computer-readable storage media, such as volatile memory and/or non-volatile memory, including but not limited to random access memory (RAM), dynamic random access memory (DRAM), static random access memory (SRAM), read-only memory (ROM), and flash memory. The memory 101 may store, for example, an operating system, an application program, a boot loader (Boot Loader), a database, other programs, etc., and may also store various application programs, various data, etc.

A processor 102 is used to run the computer-readable instructions to implement the recommendation information processing method described in any one of the above embodiments or the method described in any one of the above embodiments. For the specific implementation of each step of the method, reference may be made to the above embodiments, and the repeated parts are not described herein.

The processor 102 may be configured to execute the steps in FIG. 1 to FIG. 7. The processor 102 may be embodied as various processing apparatuses, such as a central processing unit (CPU), a network processor (NP), etc.; and may also be a digital signal processor (DSP), an application specific integrated circuit (ASIC), a field programmable gate array (FPGA) or other programmable logic devices, a discrete gate or transistor logic device, or a discrete hardware component. The central processing unit (CPU) may have an X86 or ARM architecture, etc.

The processor 102 and the memory 101 may directly or indirectly communicate with each other. For example, the processor 102 and the memory 101 may communicate through a network. The network may include a wireless network, a wired network, and/or any combination of a wireless network and a wired network. The processor 102 and the memory 101 may also communicate with each other through a system bus, which is not limited in the present disclosure.

It should be noted that the components of the electronic device 10 shown in FIG. 10 are only exemplary and non-restrictive, and the electronic device 10 may further have other components according to actual application needs. The processor 102 may control other components in the electronic device 10 to perform desired functions.

The electronic device 10 may be implemented by means of software, firmware, and/or hardware, and may be integrated in an apparatus in which a related application program is installed.

FIG. 11 shows a block diagram of an electronic device according to some other embodiments of the present disclosure.

The electronic device 11 shown in FIG. 11 may be a computer system having a dedicated hardware structure, and may perform corresponding functions when a related application program is installed.

The electronic device includes, but is not limited to, mobile terminals such as smart phones, notebooks, personal digital assistants (abbreviated as PDA), tablet personal computers (abbreviated as Tablet PC), portable media players (abbreviated as PMP), vehicle terminals (such as car navigation terminal), wearable devices, etc., and fixed terminals such as digital televisions, desktop computers, etc.

As shown in FIG. 11, a central processing unit (CPU) 111 executes various processes according to a program stored in a read-only memory (ROM) 112 or a program loaded from a storage part 118 into a random access memory (RAM) 113. In the RAM 113, data required when the CPU 111 executes various processes and the like is stored as needed. The central processing unit is only exemplary, and it may also be other types of processors, such as the various processors described above. The ROM 112, the RAM 113, and the storage part 118 may be various forms of computer-readable storage media. It should be noted that although the ROM 112, the RAM 113, and the storage part 118 are shown separately in FIG. 11, one or more of them may be combined or located in the same or different memories or storage modules.

The CPU 111, the ROM 112, and the RAM 113 are connected to each other via a bus 114. An input/output interface 115 is also connected to the bus 114.

The following components are connected to the input/output interface 115: an input part 116, such as a touch screen, a touchpad, a keyboard, a mouse, an image sensor, a microphone, an accelerometer, a gyroscope, etc.; an output part 117, including a display, such as a cathode ray tube (CRT), a liquid crystal display (LCD), a speaker, a vibrator, etc.; the storage part 118, including a hard disk, a magnetic tape, etc.; and a communication part 119, including a network interface card, such as a LAN card, a modem, etc. The communication part 119 allows communication processing to be performed via a network such as the Internet. It is easy to understand that although the components in the electronic device 11 are shown in FIG. 11 to communicate through the bus 114, they may also communicate through a network or other means, where the network may include a wireless network, a wired network, and/or any combination of a wireless network and a wired network.

A driver 1110 is also connected to the input/output interface 115 as needed. A removable medium 1111, such as a magnetic disk, an optical disc, a magneto-optical disc, a semiconductor memory, etc., is installed on the driver 1110 as needed, so that a computer program read therefrom is installed into the storage part 118 as needed.

In the case where the above series of processes are implemented by software, a program constituting the software may be installed from a network such as the Internet or a storage medium such as the removable medium 1111.

According to the embodiments of the present disclosure, the process described above with reference to the flowchart may be implemented as a computer software program. For example, some embodiments of the present disclosure include a computer program product that, when running on a computer, causes the computer to implement the method described in any one of the above embodiments. The computer program product includes computer instructions carried on a computer-readable medium, including program code for executing the method shown in the flowchart. In such an embodiment, the computer instructions may be downloaded and installed from a network through the communication part 119, or installed from the storage part 118, or installed from the ROM 112. When the computer program is executed by the CPU 111, the method of the embodiments of the present disclosure is executed.

It should be noted that, in the context of the present disclosure, a computer-readable medium may be a tangible medium that may contain or store a program for use by or in combination with an instruction execution system, apparatus or device.

The computer-readable medium may be a computer-readable storage medium, a computer-readable signal medium, or any combination of the above two.

The computer-readable storage medium includes, but is not limited to, an electrical, magnetic, optical, electromagnetic, infrared, or semiconductor system, apparatus or device, or any combination of the above. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. The computer-readable storage medium has computer instructions stored thereon, and the instructions, when executed by a processor, implement the method described in any one of the above embodiments.

The computer-readable signal medium may include a data signal propagated on a baseband or as a part of a carrier, and computer-readable program code is carried in the data signal. The data signal propagated in this way may take many forms, including but not limited to an electromagnetic signal, an optical signal, or any suitable combination of the above. The computer-readable signal medium may also be any computer-readable medium other than the computer-readable storage medium, and the computer-readable signal medium may send, propagate or transmit a program used by or in combination with an instruction execution system, apparatus or device. The program code contained on the computer-readable medium may be transmitted by any suitable medium, including but not limited to: a wire, an optical cable, RF (radio frequency), etc., or any suitable combination of the above.

The above computer-readable medium may be included in the above electronic device, or may exist alone without being assembled into the electronic device.

In some embodiments, there is further provided a computer program, including: instructions that, when executed by a processor, cause the processor to perform the method described in any one of the above embodiments. For example, the instructions may be embodied as computer program code.

In the embodiments of the present disclosure, the computer program code for performing the operations of the present disclosure may be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be executed entirely on a user computer, partly executed on a user computer, executed as an independent software package, partly executed on a user computer and partly executed on a remote computer, or entirely executed on a remote computer or server. In the case involving the remote computer, the remote computer may be connected to the user computer through any kind of network, including a local area network (LAN) or a wide area network (WAN), or it may be connected to an external computer (for example, connected by using Internet provided by an Internet service provider).

The flowchart and block diagrams in the drawings illustrate the possibly implemented architectures, functions and operations of the system, method and computer program product according to various embodiments of the present disclosure. In this regard, each block in the flowchart or block diagrams may represent a module, program segment, or part of code, which includes one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagrams and/or flowcharts, and the combination of the blocks in the block diagrams and/or flowcharts may be implemented by a dedicated hardware-based system that executes specified functions or operations, or may be implemented by a combination of dedicated hardware and computer instructions.

The functions described above may be at least partially performed by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), etc.

According to some embodiments of the present disclosure, a recommendation information processing method is provided, including: acquiring recommendation information; generating colloquial summary information according to the recommendation information; and generating audio corresponding to the summary information and playing the audio through an audio playback device.

In some embodiments, the generating audio corresponding to the summary information and playing the audio through an audio playback device includes: determining whether there is a conversation link corresponding to the audio playback device; in response to there being a conversation link corresponding to the audio playback device, sending the audio corresponding to the summary information to the audio playback device through the conversation link to play the audio; and in response to there being no conversation link corresponding to the audio playback device, establishing a conversation link with the audio playback device, and sending the audio corresponding to the summary information to the audio playback device through the conversation link to play the audio.

In some embodiments, the generating colloquial summary information according to the recommendation information includes: determining key information in the recommendation information according to semantic information of the recommendation information; determining auxiliary information associated with the key information according to the key information; and generating the colloquial summary information according to the key information and the auxiliary information.

In some embodiments, the generating the colloquial summary information according to the key information and the auxiliary information includes: generating the colloquial summary information via a machine learning model according to the key information, the auxiliary information, and prompt, where the prompt includes task description information for instructing to use a colloquial expression and one or more examples of using the colloquial expression.

In some embodiments, the processing method further includes: in response to receiving input information from a user, determining whether the input information is relevant to the recommendation information via semantic understanding on the input information; in response to the input information being relevant to the recommendation information, generating colloquial first reply information according to the input information and the recommendation information; and generating audio corresponding to the first reply information and playing the audio through the audio playback device.

In some embodiments, the processing method further includes: generating second reply information associated with the first reply information according to the input information and the recommendation information, where the second reply information includes at least one of search content or generative content associated with the first reply information; and displaying the second reply information.

In some embodiments, the generating second reply information associated with the first reply information according to the input information and the recommendation information includes: determining semantic information according to the input information, and determining a manner of generating the second reply information, where the manner includes at least one of a search manner or a generative manner; in response to the manner including the search manner, searching for content for replying to the input information according to the semantic information of the input information and the recommendation information to obtain the search content as the second reply information; in response to the manner including the generative manner, generating content for replying to the input information according to the semantic information of the input information and the recommendation information to obtain the generative content as the second reply information; and in response to the manner including the search manner and the generative manner, searching for content for replying to the input information according to the semantic information of the input information and the recommendation information to obtain the search content, and summarizing the search content to obtain the generative content, and combining the search content and the generative content to obtain the second reply information.

In some embodiments, the recommendation information comprises one or more pieces of recommendation information and the generating colloquial summary information according to the recommendation information includes: in response to acquiring each piece of recommendation information, determining a group corresponding to each piece of the recommendation information according to at least one of content or a source corresponding to each piece of the recommendation information, where different types of groups correspond to different trigger conditions, and the trigger conditions include at least one of a trigger time or a quantity threshold of recommendation information in a group; and in response to a trigger condition of a certain group being satisfied, generating summary information of the group according to recommendation information in the group.

In some embodiments, the determining a group corresponding to each piece of the recommendation information according to at least one of content or a source corresponding to each piece of the recommendation information includes: determining an urgency degree corresponding to each piece of the recommendation information via semantic understanding on the content of each piece of the recommendation information; and determining the group corresponding to each piece of the recommendation information according to the urgency degree corresponding to each piece of the recommendation information, where a group with a higher urgency degree corresponds to an earlier trigger time and a lower quantity threshold.

In some embodiments, the determining a group corresponding to each piece of the recommendation information according to at least one of content or a source corresponding to each piece of the recommendation information includes: parsing each piece of the recommendation information to identify the source corresponding to each piece of the recommendation information, where the source includes at least one of an application or a sending user; and determining the group corresponding to each piece of the recommendation information according to at least one of the application or the sending user corresponding to each piece of the recommendation information, where different applications correspond to different groups, and sending users with different priorities correspond to different groups.

In some embodiments, the determining a group corresponding to each piece of the recommendation information according to at least one of content or a source corresponding to each piece of the recommendation information includes: parsing each piece of the recommendation information to identify the source corresponding to each piece of the recommendation information, where the source includes at least one of an application or a sending user; determining a message type and an urgency degree corresponding to each piece of the recommendation information via semantic understanding on each piece of the recommendation information ; and determining the group corresponding to each piece of the recommendation information according to at least one of the application or the sending user corresponding to each piece of the recommendation information, the message type, and the urgency degree.

In some embodiments, the generating the summary information of the group according to the recommendation information in the group includes: determining key information in the recommendation information in the group according to semantic information of the recommendation information in the group in an order of sending time of the recommendation information in the group; determining auxiliary information associated with the key information according to the key information; and generating the summary information of the group using a colloquial expression according to the key information, the auxiliary information, and the sending user, where a plurality of pieces of recommendation information continuously sent by one sending user in one event are summarized together.

In some embodiments, the acquiring recommendation information includes: in response to a user turning on a broadcast function of recommendation information and configuring one or more applications corresponding to the recommendation information to be broadcast, acquiring the recommendation information corresponding to the one or more applications.

In some embodiments, the generating audio corresponding to the summary information and playing the audio through an audio playback device includes: broadcasting audio of a prompt tone configured by the user and the audio corresponding to the summary information through the audio playback device, where the prompt tone is configured to prompt the user that the broadcast is about to start.

According to some other embodiments of the present disclosure, a recommendation information processing method is provided, including: acquiring, by a client, recommendation information in a terminal and sending the recommendation information to a server; generating, by the server, colloquial summary information according to the notification information; sending, by the server, a summary complete event to the client; determining, by the client, whether there is a conversation link corresponding to an audio device in response to receiving the summary complete event; establishing, by the client, a conversation link with an audio playback device in response to there being no conversation link corresponding to the audio device; sending, by the client, a trigger message to the server in response to the conversation link being successfully established; generating, by the server, audio corresponding to the summary information according to the summary information in response to receiving the trigger message; sending, by the server, the audio corresponding to the summary information to the client; and sending, by the client, the audio corresponding to the summary information to the audio playback device through the conversation link to play the audio.

According to some yet other embodiments of the present disclosure, a recommendation information processing apparatus is provided, including: an acquisition module configured to acquire recommendation information in a terminal; a generation module configured to generate colloquial summary information according to the recommendation information; and a sending module configured to generate audio corresponding to the summary information and play the audio through an audio playback device.

According to some still other embodiments of the present disclosure, a recommendation information processing apparatus is provided, including a client and a server, where: the client is configured to acquire recommendation information in a terminal, send the recommendation information to the server, determine whether there is a conversation link corresponding to an audio device in response to receiving a summary complete event sent by the server, establish a conversation link with an audio playback device in response to there being no conversation link corresponding to the audio device, send a trigger message to the server in response to the conversation link being successfully established, receive audio corresponding to summary information sent by the server, and send the audio corresponding to the summary information to the audio playback device through the conversation link to play the audio; and the server is configured to generate colloquial summary information according to the notification information, send the summary complete event to the client, generate audio corresponding to the summary information according to the summary information in response to receiving the trigger message sent by the client, and send the audio corresponding to the summary information to the client.

According to some yet other embodiments of the present disclosure, an electronic system is provided, including: a processor; and a memory coupled to the processor and configured to store instructions that, when executed by the processor, cause the processor to perform the recommendation information processing method according to any one of the embodiments of the present disclosure.

According to some still other embodiments of the present disclosure, a computer-readable storage medium is provided, where a computer program is stored on the computer-readable storage medium, and the computer program, when executed by a processor, causes the processor to implement the recommendation information processing method according to any one of the embodiments of the present disclosure.

According to some yet other embodiments of the present disclosure, a computer program product is provided, including instructions that, when executed by a processor, cause the processor to perform the recommendation information processing method according to any one of the embodiments of the present disclosure.

According to some still other embodiments of the present disclosure, a computer program is provided, including instructions that, when executed by a processor, cause the processor to perform the recommendation information processing method according to any one of the embodiments of the present disclosure.

Although some specific embodiments of the present disclosure have been described in detail by way of examples, those skilled in the art should understand that the above examples are only for illustration, and are not intended to limit the scope of the present disclosure. Those skilled in the art should understand that the above embodiments may be modified without departing from the scope and spirit of the present disclosure. The scope of the present disclosure is defined by the appended claims.

What is claimed is

1. A recommendation information processing method, comprising:
acquiring recommendation information;
generating colloquial summary information according to the recommendation information; and
generating audio corresponding to the summary information and playing the audio through an audio playback device.

2. The recommendation information processing method of claim 1, wherein the generating audio corresponding to the summary information and playing the audio through an audio playback device comprises:
determining whether there is a conversation link corresponding to the audio playback device;
sending the audio corresponding to the summary information to the audio playback device through the conversation link to play the audio, in response to there being a conversation link corresponding to the audio playback device; and
establishing the conversation link with the audio playback device, and sending the audio corresponding to the summary information to the audio playback device through the conversation link to play the audio, in response to there being no conversation link corresponding to the audio playback device.

3. The recommendation information processing method of claim 1, wherein the generating colloquial summary information according to the recommendation information comprises:
determining key information in the recommendation information according to semantic information of the recommendation information;
determining auxiliary information associated with the key information according to the key information; and
generating the colloquial summary information according to the key information and the auxiliary information.

4. The recommendation information processing method of claim 3, wherein the generating the colloquial summary information according to the key information and the auxiliary information comprises:
generating the colloquial summary information via a machine learning model according to the key information, the auxiliary information, and prompt, wherein the prompt comprises task description information for instructing to use a colloquial expression and one or more examples of using the colloquial expression.

5. The recommendation information processing method of claim 1, further comprising:
determining whether the input information is relevant to the recommendation information via semantic understanding on the input information, in response to receiving input information from a user;
generating colloquial first reply information according to the input information and the recommendation information, in response to the input information being relevant to the recommendation information; and
generating audio corresponding to the first reply information and playing the audio through the audio playback device.

6. The recommendation information processing method of claim 5, further comprising:
generating second reply information associated with the first reply information according to the input information and the recommendation information, wherein the second reply information comprises at least one of search content or generative content associated with the first reply information; and
displaying the second reply information.

7. The recommendation information processing method of claim 6, wherein the generating second reply information associated with the first reply information according to the input information and the recommendation information comprises:
determining a manner of generating the second reply information according to semantic information of the input information, wherein the manner comprises at least one of a search manner or a generative manner;
searching for content for replying to the input information according to semantic information of the input information and the recommendation information to obtain the search content as the second reply information, in response to the manner comprising the search manner;
generating content for replying to the input information according to the semantic information of the input information and the recommendation information to obtain the generative content as the second reply information, in response to the manner comprising the generative manner; and
searching for content for replying to the input information according to the semantic information of the input information and the recommendation information to obtain the search content, and summarizing the search content to obtain the generative content, and combining the search content and the generative content to obtain the second reply information, in response to the manner comprising the search manner and the generative manner.

8. The recommendation information processing method of claim 1, wherein the recommendation information comprises one or more pieces of recommendation information and the generating colloquial summary information according to the recommendation information comprises:
determining a group corresponding to each piece of the recommendation information according to at least one of content or a source corresponding to each piece of the recommendation information, in response to acquiring each piece of the recommendation information, wherein different types of groups correspond to different trigger conditions, and the trigger conditions comprise at least one of a trigger time or a quantity threshold of recommendation information in a group; and
generating summary information of a certain group according to recommendation information in the group, in response to a trigger condition of the group being satisfied.

9. The recommendation information processing method of claim 8, wherein the determining a group corresponding to each piece of the recommendation information according to at least one of content or a source corresponding to each piece of the recommendation information comprises:
determining an urgency degree corresponding to each piece of the recommendation information via semantic understanding on the content of each piece of the recommendation information; and
determining the group corresponding to each piece of the recommendation information according to the urgency degree corresponding to each piece of the recommendation information, wherein a group with a higher urgency degree corresponds to an earlier trigger time and a lower quantity threshold.

10. The recommendation information processing method of claim 8, wherein the determining a group corresponding to each piece of the recommendation information according to at least one of content or a source corresponding to each piece of the recommendation information comprises:
parsing each piece of the recommendation information to identify the source corresponding to each piece of the recommendation information, wherein the source comprises at least one of an application or a sending user; and
determining the group corresponding to each piece of the recommendation information according to at least one of the application or the sending user corresponding to each piece of the recommendation information, wherein different applications correspond to different groups, and sending users with different priorities correspond to different groups.

11. The recommendation information processing method of claim 8, wherein the determining a group corresponding to each piece of the recommendation information according to at least one of content or a source corresponding to each piece of the recommendation information comprises:
parsing each piece of the recommendation information to identify the source corresponding to each piece of the recommendation information, wherein the source comprises at least one of an application or a sending user;
determining a message type and an urgency degree corresponding to each piece of the recommendation information via semantic understanding on each piece of the recommendation information; and
determining the group corresponding to each piece of the recommendation information according to at least one of the application or the sending user corresponding to each piece of the recommendation information, the message type, and the urgency degree.

12. The recommendation information processing method of claim 8, wherein the generating the summary information of a certain group according to the recommendation information in the group comprises:
determining key information in the recommendation information in the group according to semantic information of the recommendation information in the group in an order of sending time of the recommendation information in the group;
determining auxiliary information associated with the key information according to the key information; and
generating the summary information of the group using a colloquial expression according to the key information, the auxiliary information, and the sending user, wherein a plurality of pieces of recommendation information continuously sent by one sending user in one event are summarized together.

13. The recommendation information processing method of claim 1, wherein the acquiring recommendation information comprises:
acquiring the recommendation information corresponding to one or more applications, in response to a user turning on a broadcast function of recommendation information and configuring the one or more applications corresponding to recommendation information to be broadcast.

14. The recommendation information processing method of claim 1, wherein the generating audio corresponding to the summary information and playing the audio through an audio playback device comprises:
broadcasting audio of a prompt tone configured by the user and the audio corresponding to the summary information through the audio playback device, wherein the prompt tone is configured to prompt the user that the broadcast is about to start.

15. A recommendation information processing method, comprising:
acquiring, by a client, recommendation information in a terminal and sending the recommendation information to a server;
generating, by the server, colloquial summary information according to the recommendation information;
sending, by the server, a summary complete event to the client;
determining, by the client, whether there is a conversation link corresponding to an audio playback device in response to receiving the summary complete event;
establishing, by the client, the conversation link with the audio playback device in response to there being no conversation link corresponding to the audio playback device;
sending, by the client, a trigger message to the server in response to the conversation link being successfully established;
generating, by the server, audio corresponding to the summary information according to the summary information in response to receiving the trigger message;
sending, by the server, the audio corresponding to the summary information to the client; and
sending, by the client, the audio corresponding to the summary information to the audio playback device through the conversation link to play the audio.

16. An electronic system, comprising:
one or more processors; and
one or more memories coupled to the one or more processors and configured to store instructions, wherein the instructions, when executed by the one or more processors, cause the one or more processors to:
acquire recommendation information;
generate colloquial summary information according to the recommendation information; and
generate audio corresponding to the summary information and play the audio through an audio playback device.

17. The electronic system according to claim 16, wherein the generating audio corresponding to the summary information and playing the audio through an audio playback device comprises:
determining whether there is a conversation link corresponding to the audio playback device;
sending the audio corresponding to the summary information to the audio playback device through the conversation link to play the audio, in response to there being a conversation link corresponding to the audio playback device; and
establishing the conversation link with the audio playback device, and sending the audio corresponding to the summary information to the audio playback device through the conversation link to play the audio, in response to there being no conversation link corresponding to the audio playback device.

18. An electronic system, comprising:
one or more processors; and
one or more memories coupled to the one or more processors and configured to store instructions, wherein the instructions, when executed by the one or more processors, cause the one or more processors to execute the recommendation information processing method according to claim 15.

19. A non-transitory computer-readable storage medium, wherein a computer program is stored on the computer-readable storage medium, and the computer program, when executed by a processor, causes the processor to execute the recommendation information processing method according to claim 1.

20. A non-transitory computer-readable storage medium, wherein a computer program is stored on the computer-readable storage medium, and the computer program, when executed by a processor, causes the processor to execute the recommendation information processing method according to claim 15.
